(19) United States
(12) Patent Application Publication
(10) Pub. No.: US 2002/0056222 A1
(43) Pub. Date: May 16, 2002

(54) Fishinglure

(76) Inventor: Kent Andersen, Odense (DK)

Correspondence Address: KENT ANDERSEN, HAVNEGADE 100, DK-5000 Odense C, ODENSE, DK

(21) Appl. No.: 09/988,473

(22) Filed: Nov. 20, 2001

(30) Foreign Application Priority Data
Nov. 10, 2000 (PA) PA 2000 01673

(51) Int. Cl. A01K 85/00

(52) U.S. Cl. 43/42.5

(57) ABSTRACT

Fishing lure made of a plate of metal 1, which has its widest part across the longitudinal direction 2 at the front with an eye in each end 3 for mounting, in the front a fishing line and in the back a fishing hook 4. The lure has a bending within one-eight of the front in the longitudinal direction 5 that turns opposite a bending, which substantially includes the remaining part of the lures longitudinal direction 6.

(The lures front bending in the longitudinal direction 5 and the lures bending of the remaining part of the lures longitudinal direction 6 has a bending across 7-8 as well that turns in the same direction as the lures front bending 5.) Not claimed in the US.

The lures widest part across the longitudinal direction 2 is substantially where the front bending in the longitudinal direction 5 has its beginning 9 in the bending that turns in the opposite direction of the remaining part of the lures longitudinal direction 6. The lure is furthermore made of a plate of metal that is 0.7 mm thick or thicker.

The design of the lure creates the lure's life-like movement in the water, which is like the sheet of metal lure, and it enables the lure to be cast over long distances. This due to the front bend which stabilizes the lure's movement in the water. The front bend serves the same purpose as a spoiler on a car and allows for accurate casting over long distances. This method also means that a lure can be made from thicker metal plates o,7 mm or thicker.

### DESCRIPTION

The invention relates to a fishing lure, which is made of a metal plate. Across the longitudinal direction the lure has its widest point at the front, and the lure has an eye in each end for mounting, in the front the fishing line and in the rear the fishing hook.

There are currently different types of this kind of fishing lure available. The most popular model is bent in the longitudinal direction and is formed using a thin metal plate.

These lures have only been for trolling, as the sheet of metal is very light. Also, these lures are not designed with aerodynamics in mind, which means that they flutter through the air and do not provide distance or accuracy when casting. The movement of this kind of fishing lure in the water has been proven to attract carnivorous fish. Therefore anglers have been disappointed that these lures were not designed for casting.

The new thing about this production consists in a bending within one sixths of the front of the lure in the longitudinal direction. This bending has to turn in the opposite direction of a bending in the longitudinal direction of the remaining part of the fishing lure.

(The lures front bending in the longitudinal direction and the bending in the remaining part of the longitudinal direction has a bending across the longitudinal direction as well, that has the same direction as the front bending.) Not claimed in the US!

Furthermore the lures widest part across the longitudinal direction is substantially where the front bending in the longitudinal direction has its beginning in the bending that turns in the opposite direction in the longitudinal direction, and it is made of a plate of metal that is 0.7 mm thick or thicker.

By applying the above mentioned technique you will accomplish to make a fishing lure that has the same lifelike movement in the water as a sheet of metal lure, while it also allows for casting over long distances. This has to do with the bending in the front of the lure that stabilizes the lures movements in the water, so the lure can be made in a heavy plate of a thickness 0.7 mm or thicker, as well as functioning as the spoiler on a racing car, which makes the lure fly stable through the air.

### FIGURE APPELLATION

FIG. 1 shows fishing lure according to the invention from the side

FIG. 2 shows the same lure from above and

FIG. 3 shows the same lure from the front

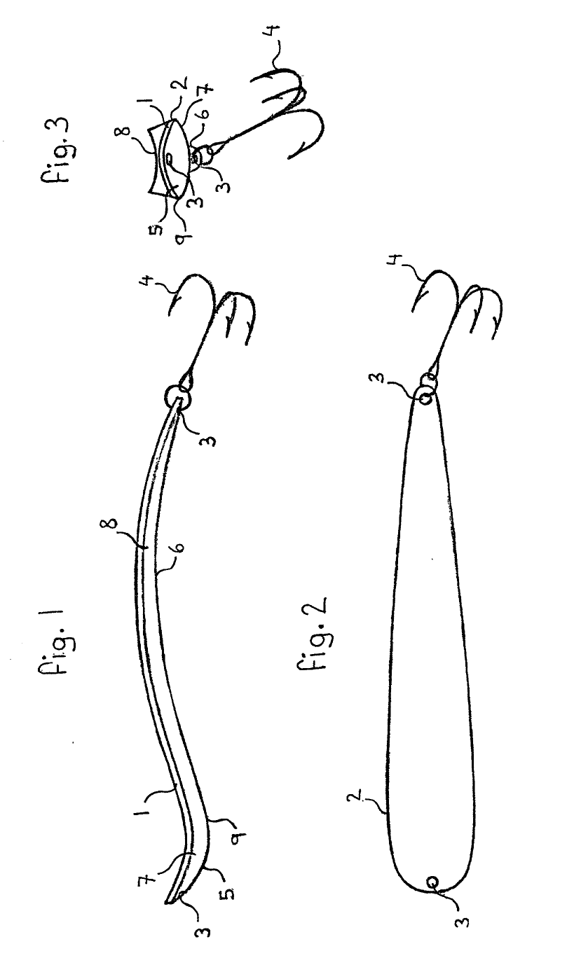

1. Fishing lure in a plate of metal (1), which has its widest part across the longitudinal direction (2) in the front with an eye in each end (3) used for mounting, in the front a fishing line and in the back a fishing hook (4) characterized by the fact that the lure has a bending within one-sixths of the front of the longitudinal direction (5) that is in the opposite direction of a bending that substantially includes the remaining part of the lure in the longitudinal direction (6).

2. Fishing lure according to claim number 1: characterized by the fact that the lure has a bending within one-eight in the front of the longitudinal direction (5) that turns the opposite way of a bending of the remaining part of the lure in the longitudinal direction (6).

3. Not claimed in the US. (Fishing lure according to claim number 1 and 2: characterized by the fact that the lures front bending in the longitudinal direction (5) and the lures bending of the remaining part in the longitudinal direction has a bending across as well (7-8), that turns in the same direction as the front of the lure (5).)

4. Fishing lure according to claims number 1, 2 and 3 (not claimed): characterized by the fact that the lures widest part across the longitudinal direction (2) is substantially where the front bending in the longitudinal direction (5) has its beginning (9) in the bending that turns in the opposite direction of the remaining part of the lure in the longitudinal direction (6).

5. Fishing lure according to claims number 1, 2, 3 (not claimed) and 4: characterized by the fact that the lure is made of a plate of metal (1) that is 0.7 mm thick or thicker.
